(19) United States
(12) Patent Application Publication
(10) Pub. No.: US 2026/0008215 A1
(43) Pub. Date: Jan. 8, 2026

(54) INJECTION UNIT AND INJECTION MOLDING MACHINE PROVIDED WITH SAME

(71) Applicant: THE JAPAN STEEL WORKS, LTD., Tokyo (JP)

(72) Inventor: Keisuke KIMURA, Tokyo (JP)

(21) Appl. No.: 19/260,967

(22) Filed: Jul. 7, 2025

(30) Foreign Application Priority Data
Jul. 8, 2024 (JP) 2024-109398

(51) Int. Cl. B29C 45/50; B29C 45/62

(52) U.S. Cl. CPC B29C 45/5008; B29C 45/62; B29C 2045/5052

(57) ABSTRACT

An injection unit comprises an injection cylinder, a screw that is housed in the injection cylinder, a front plate that is connected to the injection cylinder, a movable plate that rotatably supports the screw, a ball nut that is installed in the movable plate, ball screws that engage with the ball nut and that drive the movable plate in the axial direction of the screw, a bearing that is supported by the front plate and that rotatably supports the ball screws, and a heat insulation material that is in contact with the front plate between the injection cylinder and the front plate.

### FIELD

This application claims the benefit of Japanese Priority Patent Application No. JP 2024-109398 filed on Jul. 8, 2024, the entire contents of which are incorporated herein by reference.

This invention relates to an injection unit and an injection molding machine provided with same.

### BACKGROUND

An injection unit of an injection molding machine comprises a drive mechanism for a screw. Japanese Patent Application Laid-Open No. 2023-71233 describes a drive mechanism comprising a front plate that is connected to an injection cylinder, and a movable plate that rotatably supports the screw. Bearings are provided in the front plate, and ball screws are rotatably supported by these bearings. Ball nuts are installed in the movable plate. Rotation of the ball screws move the ball nuts, which drive the movable plate and the screw supported by the movable plate in the axial direction of the screw.

### SUMMARY

The front plate is connected to the injection cylinder and supports the bearing. Therefore, heat from the injection cylinder is transferred to the bearing through the front plate and may affect the operation of the bearing.

The purpose of this disclosure is to provide an injection unit that can mitigate the effects of heat on a bearing provided in the front plate.

The injection unit of the present disclosure comprises a front plate that is connected to an injection cylinder, a bearing that is supported by the front plate, and a heat insulation material that is in contact with the front plate between the injection cylinder and the front plate.

### BRIEF DESCRIPTION OF THE DRAWINGS

The above features and advantages of the present invention will become more apparent based on the following description of a certain preferred embodiment taken in conjunction with the accompanying drawings, in which:

FIG. 1 is a schematic front view of an injection molding machine according to an embodiment of the present disclosure;

FIG. 2 is a top view of the injection unit of the injection molding machine shown in FIG. 1;

FIG. 3 is an enlarged view of area A shown in FIG. 2;

FIG. 4 is a cross-sectional view taken along line A-A shown in FIG. 3; and

FIG. 5 is a front view of an insulation plate according to the present disclosure.

### DETAILED DESCRIPTION

An embodiment of the present disclosure is described below with reference to the drawings. In the following description and drawings, the axial direction of the injection cylinder and screw is referred to as the X-direction. The X-direction is parallel to the horizontal direction. The direction from the injection unit to a mold-clamping unit and an injection direction of a material to be injected (injection molding material) is referred to as the +X-direction. The direction from the mold-clamping unit to the injection unit is referred to as the −X-direction. The vertical direction is referred to as the Z-direction.

### Overall Configuration

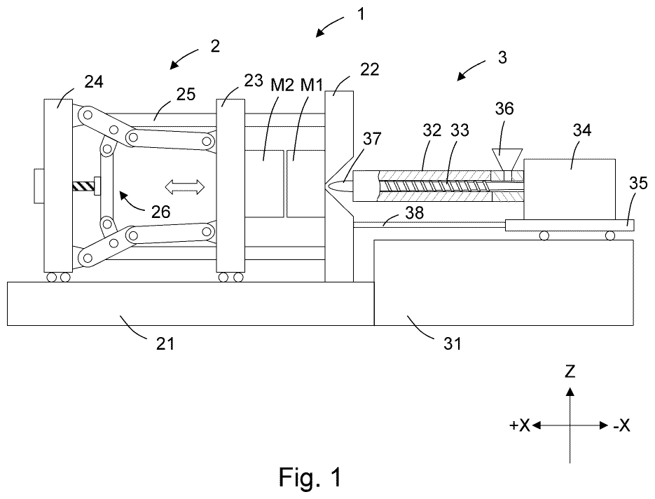

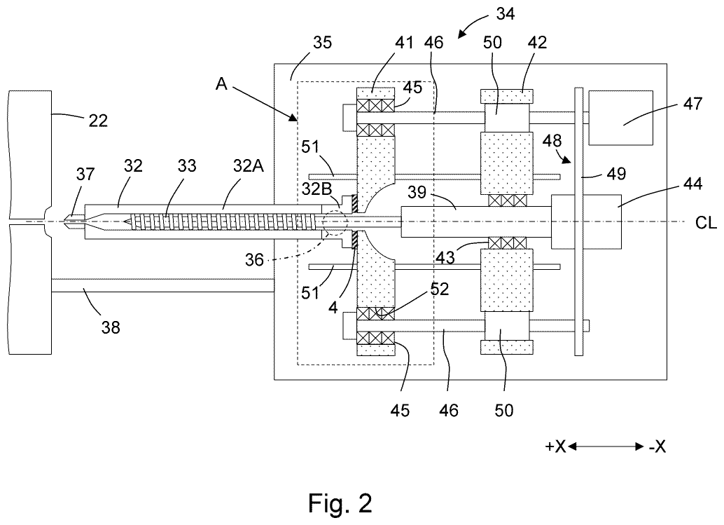

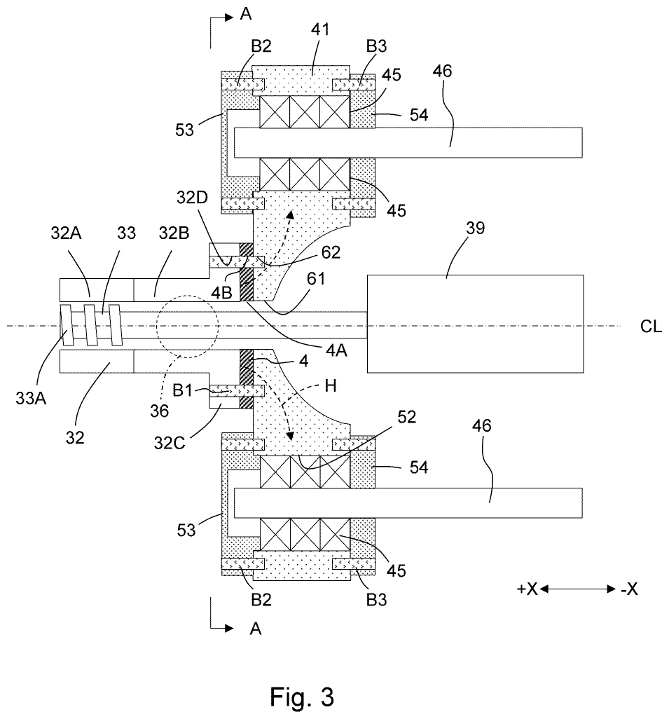

FIG. 1 shows a schematic front view of injection molding machine 1 according to an embodiment of the present disclosure. FIG. 2 shows a top view of injection unit 3 of injection molding machine 1 shown in FIG. 1. FIG. 3 is an enlarged view of area A in FIG. 2 and shows the front plate and the surrounding structure of the front plate. Injection molding machine 1 generally comprises mold-clamping unit 2 that secures the mold and that opens and closes the mold, and injection unit 3 that heats and melts a material to be injected and that injects the material.

### Mold-Clamping Unit 2

As shown in FIG. 1, mold-clamping unit 2 comprises fixed platen 22 that is fixed on bed 21 and to which fixed mold M1 is attached, mold-clamping housing 24 that can slide on bed 21, and movable platen 23 that can slide on bed 21 and to which movable mold M2 is attached. Fixed platen 22 and clamping housing 24 are connected by a plurality of tie bars 25. Mold-clamping mechanism 26 is provided between movable platen 23 and mold-clamping housing 24 for opening and closing the mold. Mold-clamping mechanism 26 is configured as a toggle mechanism but may also be configured as a hydraulic mold-clamping cylinder.

### Injection Unit 3

Injection unit 3 is provided on base 31. Injection unit 3 comprises injection cylinder 32, screw 33 that is housed in injection cylinder 32, drive mechanism 34 that drives screw 33, and support plate 35 that supports drive mechanism 34. Drive mechanism 34 rotates and drives screw 33 in the X-direction. Hopper 36, which supplies material, is connected near the end of injection cylinder 32 in the −X-direction. Injection nozzle 37, which injects the material, is provided at the end of injection cylinder 32 in the +X-direction.

As shown in FIGS. 2 and 3, injection cylinder 32 comprises main body section 32A, and supply section 32B that is provided on the −X-direction side of main body section 32A and to which an injection molding material is supplied. Hopper 36 is connected to supply section 32B. Supply section 32B has almost the same external shape as main body section 32A and includes an internal space through which screw 33 passes. Screw 33 of main body section 32A includes flight 33A for transferring and kneading the material, while screw 33 of supply section 32B does not include flight 33A.

### Nozzle Touch Device 38

As shown in FIGS. 1 and 2, injection unit 3 comprises nozzle touch device 38. Nozzle touch device 38 connects support plate 35 and fixed platen 22. Nozzle touch device 38 is configured, for example, as a mechanism that uses a hydraulic cylinder or a mechanism that uses ball screws. Nozzle touch device 38 drives support plate 35 in the X-direction, whereby injection nozzle 37 touches a sprue bushing (not shown) of the mold.

### Drive Mechanism 34 of Injection Unit 3

As shown in FIG. 2, drive mechanism 34 of screw 33 comprises front plate 41 that supports injection cylinder 32 and movable plate 42 that is located on the −X-direction side of front plate 41. Front plate 41 and movable plate 42 are supported by support plate 35. Support part 39 of screw 33 is connected to the end of screw 33 in the −X-direction, and support part 39 is rotatably supported by movable plate 42 via bearing 43. Thus, screw 33 is rotatably supported on movable plate 42 via support part 39.

Drive mechanism 34 comprises plasticizing motor 44 that is provided on support plate 35 and a rotation transmission mechanism (not shown). The rotation transmission mechanism comprises pulleys that are connected to plasticizing motor 44, a timing belt that is wound around the pulleys, and the like. Plasticizing motor 44 rotates and drives support part 39 through the rotary transmission mechanism, thereby rotating and driving screw 33.

Drive mechanism 34 comprises two ball screws 46 that are supported on front plate 41 via bearings 45, injection motor 47 that is provided on support plate 35, and rotation transmission mechanism 48. The two ball screws 46 are provided on both sides of central axis CL of injection cylinder 32 when viewed in the Z-direction. Rotation transmission mechanism 48 comprises pulleys (not shown) that are connected to injection motor 47 and timing belt 49 that is wound around the pulleys. Timing belt 49 is looped around the pulleys of two ball screws 46. Injection motor 47 drives the two ball screws 46 at the same rotational speed by means of rotational transmission mechanism 48.

Ball nuts 50, which each engage with a respective ball screw 46, are installed in movable plate 42. Since ball screws 46 are fixed at positions relative to front plate 41 in the X-direction, rotation of ball screws 46, causes ball nuts 50 to move in the X-direction along ball screws 46. As a result, ball screws 46 drive movable plate 42 in the X-direction as well as screw 33 that is supported by movable plate 42. Movable plate 42 can move in the X-direction while being guided by guide rails 51 on support plate 35.

Front plate 41, which is connected to injection cylinder 32, comprises through holes 52 in which bearings 45 are attached. Bearings 45, which are supported in through holes 52, rotatably support ball screws 46. The number of bearings 45 is not limited, but at least one bearing 45 should be provided. During injection, injection cylinder 32 receives a reaction force in the −X-direction, which is transmitted to front plate 41 and presses bearings 45 in the −X direction. Therefore, bearings 45 are configured as thrust bearings.

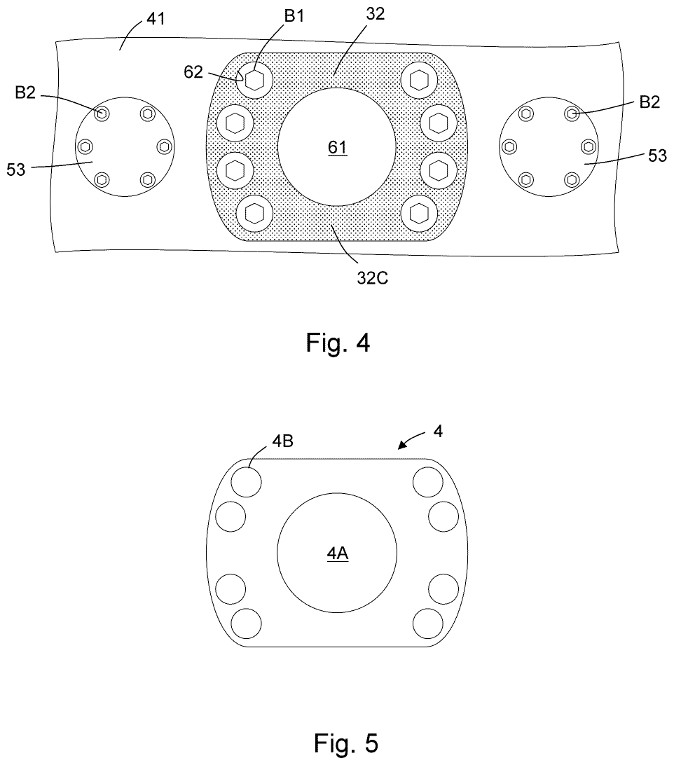

FIG. 4 is a cross-sectional view taken along the line A-A shown in FIG. 3. As shown in FIGS. 3 and 4, front plate 41 includes central hole 61 through which screw 33 passes and a plurality of threaded holes 62 arranged around central hole 61. Flange 32C is provided at the −X-direction end of supply section 32B, and injection cylinder 32 is fixed to front plate 41 by bolts B1 that pass through holes 32D and the plurality of threaded holes 62 in flange 32C. The cross-sectional area of the face orthogonal to the X-direction of flange 32C is larger than the cross-sectional area of the face orthogonal to the X-direction of main body section 32A.

Two front cover members 53 are located at the side directions of flange 32C. As shown in FIGS. 3 and 4, front cover members 53 are fixed to front plate 41 by bolts B2 and thus cover the +X-direction ends of through holes 52. The −X-direction ends of through holes 52 are covered by rear cover members 54. Rear cover members 54 are fixed to front plate 41 by bolts B3. Bearings 45 are positioned between front cover members 53 and rear cover members 54 and are pressed in the −X-direction by front cover members 53. This arrangement provides bearings 45 with a preload in the −X-direction.

### Heat Insulation Plate 4

As shown in FIGS. 2 and 3, heat insulation plate (an example of heat insulation material) 4 is provided between injection cylinder 32 and front plate 41. Heat insulation plate 4 is in contact with front plate 41 and supply section 32B. During operation of injection molding machine 1, injection cylinder 32 becomes hot, and heat H is thus transferred from injection cylinder 32 to front plate 41 as shown by the dashed-line arrows in FIG. 3. Heat H causes thermal deformation of the elements of bearings 45 (inner ring, outer ring, and balls), and excessive temperature rise of the grease-filled inside bearings 45. In this embodiment, heat insulation plate 4 limits the transfer of heat H from injection cylinder 32 to front plate 41, thus mitigating the thermal effects on bearings 45. The material of heat insulation plate 4 is not limited as long as it has lower thermal conductivity than front plate 41 (usually made of iron), and examples of the material include resins such as bakelite and engineering plastics.

Heat insulation plate 4 can be placed, for example, between main body section 32A and supply section 32B. However, supply section 32B may also become hot due to heat from heaters (not shown) in main body section 32A and heat conduction from the resin inside injection cylinder 32. In this embodiment, the transfer of heat to front plate 41 can be restricted even if the temperature of supply section 32B becomes high.

The reaction force during injection also acts on heat insulation plate 4. However, since heat insulation plate 4 generally does not have large compressive strength, the compressive stress on heat insulation plate 4 is preferably minimized. When heat insulation plate 4 is placed between main body section 32A and supply section 32B, the area of heat insulation plate 4 is about the same as the cross-sectional area of injection cylinder 32. In contrast, providing heat insulation plate 4 to contact flange 32C of supply section 32B facilitates securing a larger area. This arrangement reduces the compressive stress applied to heat insulation plate 4 and reduces deterioration of heat insulation plate 4.

FIG. 5 shows a front view of heat insulation plate 4. Heat insulation plate 4 is a plate material having the same shape and size as a rear end surface of supply section 32B in the injection direction (the end surface of flange 32C in the −X-direction). Heat insulation plate 4 may be smaller than the rear end surface of flange 32C in the injection direction, but as mentioned above, making the area of heat insulation plate 4 as large as possible is advantageous. Although not shown in FIG. 4, the periphery of heat insulation plate 4 in this embodiment has the same shape and size as the periphery of the end face of flange 32C of supply section 32B in the −X-direction.

Heat insulation plate 4 includes the same multiple openings as front plate 41, i.e., central hole 4A through which screw 33 passes and a plurality of holes 4B through which bolts B1 pass. Heat insulation plate 4 is supported on front plate 41 together with injection cylinder 32 by bolts B1. Central hole 4A, the inner space of supply section 32B and central hole 61 are concentric and have the same diameter. Each of the plurality of holes 32D in supply section 32B and holes 4B as well as screw holes 62 are also concentric and have the same diameter.

Although the invention has been described above in connection with several preferred embodiments thereof, it will be understood by those skilled in the art that these embodiments are provided solely for illustrating the invention and do not limit the scope of the appended claims.

### LIST OF REFERENCE NUMERALS

1 injection molding machine
2 mold-clamping unit
3 injection unit
4 heat insulation plate
32 injection cylinder
32B supply section
32C flange
33 screw
41 front plate
42 movable plate
45 bearings
46 ball screw
50 ball nut

1. An Injection unit, comprising:
an injection cylinder;
a screw that is housed in said injection cylinder;
a front plate that is connected to said injection cylinder;
a movable plate that rotatably supports said screw;
a ball nut that is installed in said movable plate;
ball screws that engage with said ball nut and that drive said movable plate in an axial direction of said screw;
a bearing that is supported by said front plate and that rotatably supports said ball screws; and
a heat insulation material that is in contact with said front plate between said injection cylinder and said front plate.

2. The injection unit according to claim 1, wherein said injection cylinder comprises a supply section that supplies an injection molding material and that is located at a rear end in an injection direction of said injection molding material, and wherein said heat insulation material is in contact with said supply section.

3. The injection unit according to claim 2, wherein said supply section comprises a flange at the rear end in said injection direction, and wherein said heat insulation material is a plate having the same shape and size as a rear end surface of said flange in said injection direction.

4. An injection molding machine comprising an injection unit, and a mold-clamping unit that supports a mold and that opens and closes said mold,
wherein said injection unit comprises:
an injection cylinder;
a screw that is housed in said injection cylinder;
a front plate that is connected to said injection cylinder;
a movable plate that rotatably supports said screw;
a ball nut that is installed in said movable plate;
ball screws that engage with said ball nut and that drive said movable plate in an axial direction of said screw;
a bearing that is supported by said front plate and that rotatably supports said ball screws; and
a heat insulation material that is in contact with said front plate between said injection cylinder and said front plate.

5. The injection molding machine according to claim 4, wherein said injection cylinder comprises a supply section that supplies an injection molding material and that is located at a rear end in an injection direction of said injection molding material, and wherein said heat insulation material is in contact with said supply section.

6. The injection molding machine according to claim 5, wherein said supply section comprises a flange at the rear end in said injection direction, and wherein said heat insulation material is a plate having the same shape and size as a rear end surface of said flange in said injection direction.
